(19) United States
(12) Patent Application Publication
(10) Pub. No.: US 2017/0294706 A1
(43) Pub. Date: Oct. 12, 2017

(54) ANTENNA SYSTEM AND ELECTRONIC DEVICE

(71) Applicant: FUJITSU LIMITED, Kawasaki-shi (JP)

(72) Inventor: Yohei KOGA, Kawasaki (JP)

(21) Appl. No.: 15/456,305

(22) Filed: Mar. 10, 2017

(30) Foreign Application Priority Data
Apr. 6, 2016 (JP) 2016-076671

(51) Int. Cl. H01Q 1/24; H04M 1/02; H01Q 1/38; H01Q 21/30; H04B 1/3805; H01Q 21/24

(52) U.S. Cl. CPC H01Q 1/243; H04B 1/3805; H01Q 21/245; H01Q 1/38; H01Q 21/30; H01Q 1/24; H04M 1/02

(57) ABSTRACT

An antenna system includes a ground which is disposed in a housing and has an end side; a first antenna element which includes a first open-end and a feeding point, and is exposed to an outside of the housing on the side of the first open-end; a second antenna element which includes the feeding point and a second open-end, is disposed between the end side and the first antenna element, and is branched from the first antenna element at a branching point, a section between the branching point and the second open-end being disposed in the housing or being covered with the housing and the first antenna element; and a metal plate which includes a portion connected to the ground and an end portion disposed near the first open-end, a portion of the metal plate near to the end portion being exposed to an outside of the housing.

### CROSS-REFERENCE TO RELATED APPLICATION

This application is based upon and claims the benefit of priority of the prior Japanese Patent Application No. 2016-076671, filed on Apr. 6, 2016, the entire contents of which are incorporated herein by reference.

### FIELD

The embodiments discussed herein are related to an antenna system and an electronic device.

### BACKGROUND

An antenna for a communication terminal apparatus including a feeding element which is fed unbalanced from one end, and a passive element placed in substantially parallel to the feeding element at a distance of about 1/10 or less of a wavelength at a frequency used for transmission and reception, and is set to a length to resonate when the feeding element is excited has been proposed (for example, in Japanese Laid-open Patent Publication No. 2003-198410).

The feeding element of the antenna for a communication terminal apparatus is built in a housing. A related art antenna for a communication terminal apparatus responds to a change in communication characteristics caused when a user holds the communication terminal apparatus with a built-in feeding element (an antenna element) in hand or places the communication terminal apparatus on the head.

When the antenna element is exposed to the housing, or when a metal plate connected to a ground plane is exposed to the housing, the user directly touches the antenna element or the metal plate.

In a related art antenna for a communication terminal apparatus, no measures have been taken with respect to the change in communication characteristics in this case.

### SUMMARY

According to an aspect of the invention, an antenna system includes: a ground plane configured to be disposed inside of a housing and have an end side; a first antenna element configured to include a first open end and a feeding point disposed at a certain position near the end side, the first antenna element being extend from the feeding point to the first open end, the first antenna element being exposed to an outside of the housing on the side of the first open end; a second antenna element configured to include the feeding point and a second open end and be disposed between the end side and the first antenna element in a plan view, the second antenna element being branched from the first antenna element at a branching point between the feeding point and the first open end and extending to the second open end, a section between the branching point and the second open end being disposed inside of the housing or being covered with the housing and the first antenna element; and a metal plate configured to include a connecting portion connected to the ground plane and an end portion disposed adjacent to the first open end, and extend from the connecting portion to the end portion, a portion of the metal plate near to the end portion being exposed to an outside of the housing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an electronic device including an antenna system;

FIG. 2 illustrates the antenna system;

FIG. 3 illustrates a frequency characteristic of a parameter of the antenna system;

FIG. 4 illustrates current distribution of the antenna system;

FIG. 5 illustrates current distribution of the antenna system;

FIG. 6 illustrates current distribution of the antenna system;

FIG. 7 illustrates a simulation model of a first comparative antenna system;

FIG. 8 illustrates a simulation model of the antenna system;

FIG. 9 illustrates a frequency characteristic of a parameter obtained in the first comparative antenna system illustrated in FIG. 7;

FIG. 10 illustrates a simulation model of a second comparative antenna system;

FIG. 11 illustrates a frequency characteristic of a parameter of the second comparative antenna system;

FIG. 12 illustrates antenna systems according to first and second alternative embodiments of the embodiment;

FIG. 13 illustrates the antenna systems according to the first and the second alternative embodiments of the embodiment;

FIG. 14 illustrates an antenna system according to a third alternative embodiment of the embodiment; and

FIG. 15 illustrates a frequency characteristic of a parameter of the antenna system according to the third alternative embodiment of the embodiment.

### DESCRIPTION OF EMBODIMENTS

Since the technology described in the BACKGROUND has the drawback, it is accordingly desired to provide an antenna system and an electronic device with desirable communication characteristics even when a conducting state between an antenna element and a metal plate connected to a ground plane is changed via a human body.

Hereinafter, an antenna system and an electronic device according to the embodiment will be described.

### Embodiments

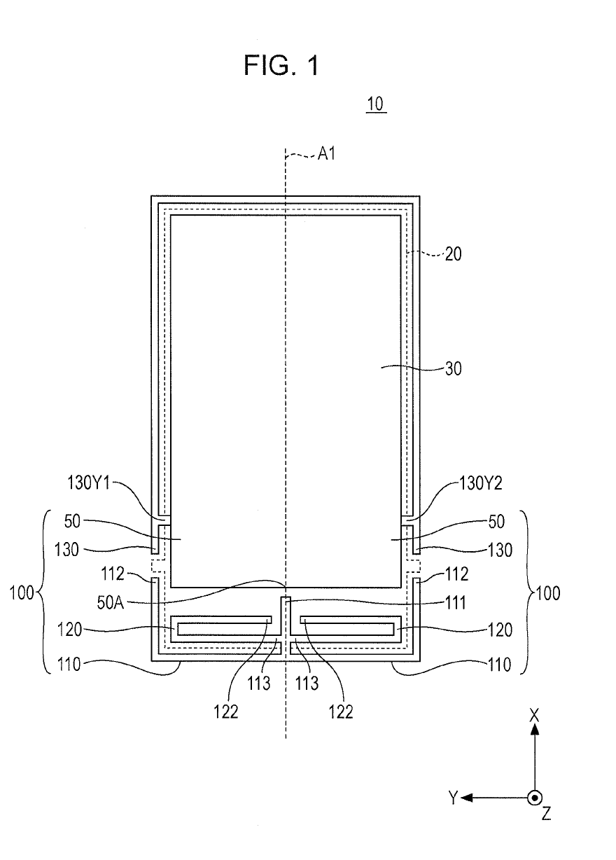

FIG. 1 illustrates an electronic device 10 including an antenna system 100. Here, an XYZ coordinate system which is an orthogonal coordinate system is used. A view from an XY plane is referred to as a plan view.

The electronic device 10 includes a housing 20, a wiring substrate 30, and the antenna system 100. The antenna system 100 includes a ground plane 50, antenna elements 110 and 120, and a bezel 130. The electronic device 10 illustrated in FIG. 1 includes two antenna systems 100. Here, two antenna systems 100 are symmetric to a central axis A1 which is parallel to an X-axis of the ground plane 50, for example.

The electronic device 10 is a portable electronic device having a communication function, such as a smartphone terminal, a mobile phone terminal, a tablet computer, or a game terminal machine, for example.

The housing 20 contains the wiring substrate 30 and a part of the antenna systems 100. The housing 20 is made of an insulating material, such as resin, and a part of which may be made of metal in a range in which radiation properties of the antenna systems 100 are not affected.

In FIG. 1, an outer shape (a contour) of the housing 20 on the XY plane is depicted by a broken line. When the electronic device 10 is a smartphone terminal, for example, and a display panel and a touch panel are disposed along the XY plane on a positive direction side in a Z-axis of the wiring substrate 30, the housing 20 is disposed to cover the wiring substrate 30 on a negative direction side in the Z-axis.

In FIG. 1, the outer shape (the contour) of the housing 20 depicted by a broken line is positioned inside of a part of the antenna element 110 and the bezel 130. This is because a part of the antenna element 110 and the bezel 130 are exposed to a side surface of the housing 20. A part of the antenna element 110 and the bezel 130 form a part of an outer surface of the side surface of the electronic device 10.

As illustrated in FIG. 1, a part of the antenna element 110 and the bezel 130 may be situated outside of the housing 20 or may be situated on the same plane with the housing 20. A part of the antenna element 110 and the bezel 130 may be exposed to the side surface of the housing 20 at a position to be offset slightly inside of the housing 20.

Here, the side surface of the electronic device 10 refers to as a surface of the outside surface of the electronic device 10 excluding surfaces extending along the XY plane on the positive direction side in the Z-axis and on the negative direction side in the Z-axis, and refers to as a surface extending in the Z-axis direction.

The housing 20 does not necessarily have to have a resin part on the side surface. In this case, the side surface of the housing 20 may be formed by a part of the antenna element 110 and the bezel 130. That is, a part of the antenna element 110 and the bezel 130 may be a part of the housing 20 or the portion of the side surface of the housing 20.

The wiring substrate 30 is a wiring substrate compliant with a flame retardant type 4 (FR-4) standard, for example, and includes a metal layer disposed on a front surface, a back surface, or an inner layer. Here, the ground plane 50 is a metal layer disposed on the surface of the wiring substrate 30 on the positive direction side in the Z-axis (i.e., the back surface), for example. A wireless module which supplies electric power to the antenna system 100, and a processing unit or a processor which performs arithmetic processing desired for an operation of the electronic device 10 are mounted on the wiring substrate 30. The processing unit is a central processing unit (CPU) chip, for example.

The ground plane 50 is used as a ground potential layer of the antenna system 100. The ground plane 50 may also be considered as a ground plate or an earth plate.

The antenna element 110 extends, for example, from a feeding unit 111 near a central point 50A in the y-axis direction to an open end 112, where the antenna element 110 is disposed on a negative direction side in the X-axis of the ground plane 50 and has a shape similar to a U-shape in a plan view. A T-shaped antenna element in which two U-shaped antenna elements 110 are combined is illustrated in FIG. 1 in order to illustrate combined two antenna elements 110.

The antenna element 110 is a monopole antenna which includes the feeding unit 111 and the open end 112, and is an example of a first antenna element. As described above, a part of the antenna element 110 forms a part of the outer surface of the side surface of the electronic device 10.

The antenna element 120 is branched at a branching point 113 between the feeding unit 111 and the open end 112, and extends to an open end 122. Two antenna elements 120 disposed symmetric to the central axis Al are illustrated in FIG. 1.

The antenna element 120 is a monopole antenna which includes a feeding unit 111 and an open end 122, and is an example of a second antenna element. A section between the feeding unit 111 and the branching point 113 of the antenna element 120 is shared by the antenna element 110.

A section between the branching point 113 and the open end 122 of the antenna element 120 is situated between the ground plane 50 and the antenna element 110 in a plan view. Therefore, the antenna element 120 is not exposed to the outside of the electronic device 10, and a user is not able to touch the antenna element 120 from the outside of the electronic device 10.

The section between the branching point 113 and the open end 122 of the antenna element 120 is situated inside of the housing 20, and is contained inside of the housing 20. Here, a form in which the section between the branching point 113 and the open end 122 is disposed inside of the housing 20 will be described, but the section between the branching point 113 and the open end 122 may be situated outside of the housing 20, and may be covered with the housing 20 and the antenna element 110 so as not to be exposed to the outside of the electronic device 10. An example of this is a case where the antenna element 120 is disposed in a groove portion provided along the side surface of the housing 20, and the antenna element 110 is provided to cover the groove portion.

The antenna elements 110 and 120 may desirably be integrally formed of a metal plate, such as copper, for example, and held by the housing 20.

The bezel 130 is a metal plate which is U-shaped in a plan view and includes connecting portions 130Y1 and 130Y2 connected to the ground plane 50. The bezel 130 is, for example, a plate or a decorative plate provided for the purpose of decoration of an exterior of the electronic device 10 or a plate or a protective plate provided to protect a display panel.

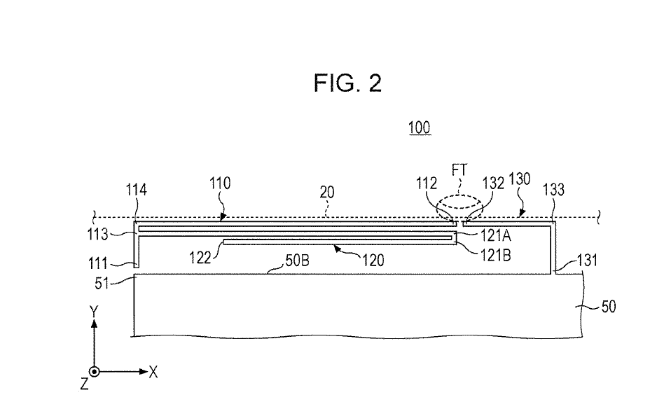

FIG. 2 illustrates the antenna system 100. An antenna system 100 illustrated in FIG. 2 and the antenna system 100 illustrated in FIG. 1 are slightly different in shape, different in directions in which the antenna element 110 and the antenna element 120 extend, but are the same in configuration.

A ground plane 50 includes a corner 51 situated on the negative direction side in the X-axis and on a positive direction side in a Y-axis, and an end side 50B extending along the X-axis.

The antenna element 110 is an inverted-L-shaped antenna element which includes a feeding unit 111, an open end 112, a branching point 113, and a bent portion 114, and is an example of a first antenna element. The open end 112 is an example of a first open end. The antenna element 110 is a monopole antenna.

The feeding unit 111 of the antenna element 110 is situated near the corner 51 of the ground plane 50. The feeding unit 111 is connected to a wireless module via a core wire of a coaxial cable or a microstrip line, for example, and receives electric power. A shielding wire of a coaxial cable or a wire of ground potential included a microstrip line is connected to the corner 51 of the ground plane 50. The corner 51 is an example of a predetermined or certain point on the end side 50B.

The antenna element 110 extends in the positive direction of the Y-axis so as to separate from the end side 50B from the feeding unit 111, is bent in the positive direction of the X-axis at the bent portion 114, and extends to the open end 112 as illustrated in FIG. 2.

The branching point 113 is situated between the feeding unit 111 and the bent portion 114. A section between the feeding unit 111 and the bent portion 114 is an example of a first line, and a section between the bent portion 114 and the open end 112 is an example of a second line.

The antenna element 120 includes a feeding unit 111, a branching point 113, bent portions 121A and 121B, and an open end 122, and is an example of a second antenna element. The open end 122 is an example of a second open end. The antenna element 120 is a monopole antenna.

The antenna element 120 extends from the feeding unit 111 in the positive direction of the Y-axis so as to separate from the end side 50B, is branched from the antenna element 110 at the branching point 113, and extends to the bent portion 121A in the positive direction of the X-axis. The antenna element 120 is bent at the bent portion 121A in the negative direction of the Y-axis, extends to the bent portion 121B, is bent at the bent portion 121B in the negative direction of the X-axis, and extends to the open end 122.

The antenna elements 110 and 120 are integrally formed of a metal plate, such as copper, for example, and held by the housing 20.

The bezel 130 includes a connecting portion 131, an open end 132, and a bent portion 133. The bezel 130 is connected to the end side 508 of the ground plane 50 at the connecting portion 131, extends from the connecting portion 131 in the positive direction of the Y-axis so as to separate from the end side 50B, is bent at the bent portion 133 in the negative direction of the X-axis, and extends to the open end 132. The bezel 130 is an example of a metal plate, the connecting portion 131 is an example of a connecting portion, and the open end 132 is an example of an end portion.

The open end 132 is situated at the same position as the open end 112 of the antenna element 110 in the y-axis direction and is disposed adjacent to the open end 112 in the X-axis direction. That the open end 132 is disposed adjacent to the open end 112 is that the open end 132 is situated adjacent to the open end 112 at a predetermined distance not in contact with the open end 112.

The predetermined distance or gap between the open end 132 and the open end 112 in the X-axis direction is a distance equivalent to a width of a person's finger, for example, and is desirable to be equal to or less than an average width of a person's finger. It is desirable that a space between the open end 132 and the open end 112 is filled with resin of the housing 20, and that a metal structure of the same potential as that of the open end 132 or 112 does not exist. When the predetermined distance between the open end 132 and the open end 112 in the X-axis direction is sufficiently short, the open end 132 may be situated near the open end 112.

The predetermined distance between the open end 132 and the open end 112 in the X-axis direction is set to be equal to or less than an average width of a person's finger from the following reason. Since the section from the bent portion 114 to the open end 112 of the antenna element 110 and the section from the bent portion 133 to the open end 132 of the bezel 130 are exposed to the side surface of the housing 20, when a user's finger touches to straddle the open end 112 and the open end 132, the open end 112 and the open end 132 are made to conduct with each other via the user's finger.

The antenna system 100 provides desirable communication characteristics both when the open end 112 and the open end 132 are made to conduct with each other by the user's finger and when are not made to conduct. Details thereof will be described later.

In FIG. 2, an outer shape (a contour) of the housing 20 depicted by a broken line is situated outside of the both sections from the bent portion 114 to the open end 112 of the antenna element 110 and from the bent portion 133 to the open end 132 of the bezel 130.

This is because the section from the bent portion 114 to the open end 112 and the section from the bent portion 133 to the open end 132 are exposed to the side surface of the housing 20. The section from the bent portion 114 to the open end 112 and the section from the bent portion 133 to the open end 132 form a part of the outer surface of the side surface of the electronic device 10.

The section from the bent portion 114 to the open end 112 and the section from the bent portion 133 to the open end 132 may be situated inside of the housing 20 as illustrated in FIG. 2 or may be on the same surface with the housing 20. The section from the bent portion 114 to the open end 112 and the section from the bent portion 133 to the open end 132 may be exposed to the side surface of the housing 20 at a position to be offset slightly outside of the housing 20.

When the user holds the electronic device 10 in hand, when the finger FT touches the open end 112 and the open end 132 to straddle the space between the open end 112 and the open end 132 as depicted by a broken line in FIG. 2, the open end 112 and the open end 132 are made to conduct with each other. When the finger FT does not touch the open end 112 and the open end 132 to straddle the space between the open end 112 and the open end 132, the open end 112 and the open end 132 are not conducting.

As described above, the communication characteristics of the antenna system 100 change between the situation where the open end 112 and the open end 132 are made to conduct with each other by the finger FT and the situation where the open end 112 and the open end 132 are not conducting, but the antenna system 100 can communicate at 800 MHz in either case. A conducting state and a non-conducting state between the open end 112 and the open end 132 may be created when the user moves the hand while the user touches an outer periphery of the electronic device 10 with the finger FT, the palm, or the like, and the antenna system 100 can communicate at 800 MHz in either case.

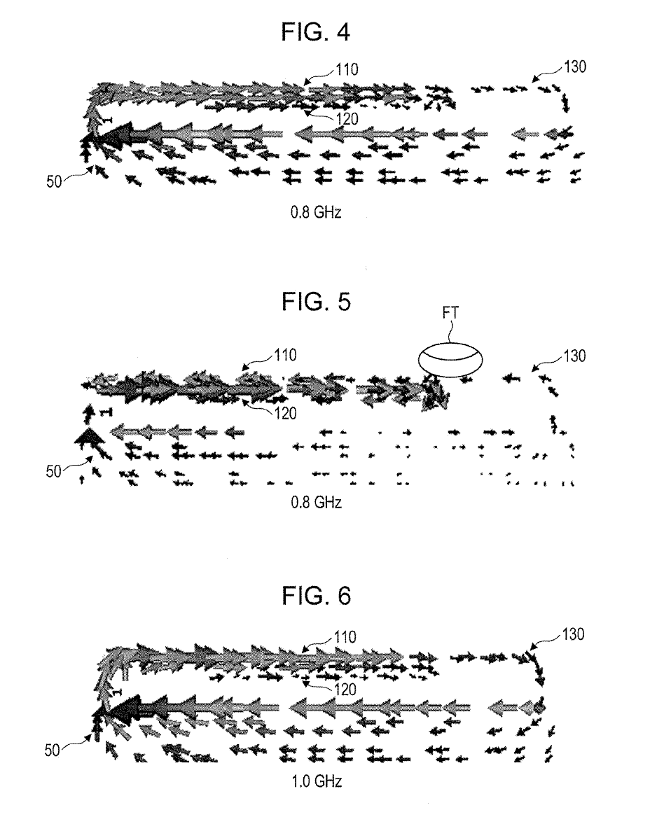

Lengths of the antenna elements 110 and 120 will be described with reference to current distribution illustrated in FIGS. 4 and 5.

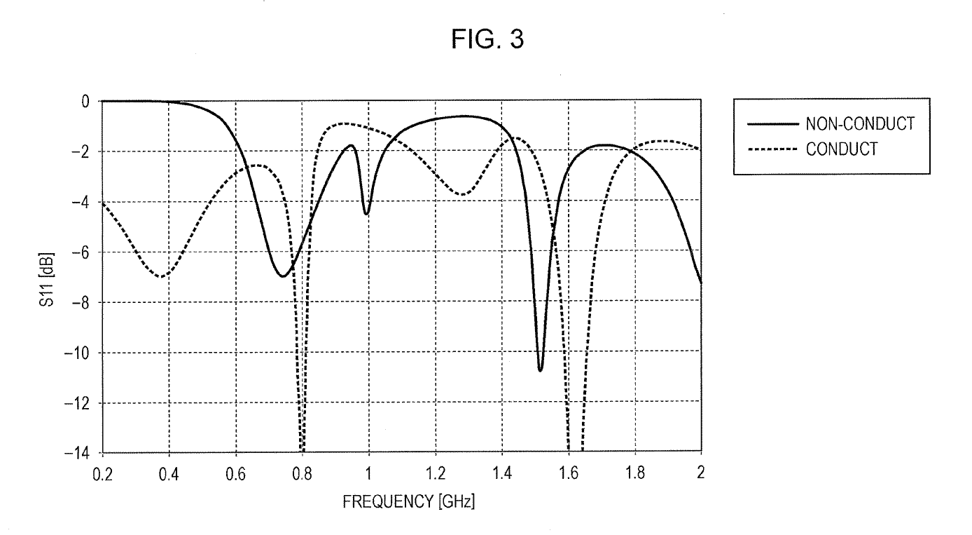

FIG. 3 illustrates a frequency characteristic of an S11 parameter of the antenna system 100 illustrated in FIG. 2. In FIG. 3, a frequency characteristic when the gap between the open end 112 and the open end 132 are in the non-conducting state (a non-conduct state) is depicted by a solid line, and a frequency characteristic when the gap between the open end 112 and the open end 132 are in the conducting state by using a finger is depicted by a broken line.

In the frequency characteristic in the non-conducting state depicted by a solid line, a desirable value of equal to or less than −5 dB is obtained at target 800 MHz.

Also in the frequency characteristic in the conducting state depicted by a broken line, a desirable value of equal to or less than −5 dB is obtained at target 800 MHz.

FIGS. 4 and 5 illustrate current distribution of the antenna system 100. The current distribution illustrated in FIGS. 4 and 5 is obtained in an electromagnetic field simulation. FIG. 4 illustrates current distribution when the gap between the open end 112 and the open end 132 are not conducting (non-conduct), and FIG. 5 illustrates current distribution when the gap between the open end 112 and the open end 132 are in the conducting state.

In FIGS. 4 and 5, orientation of arrows indicates a phase of the current, and magnitude of the arrows indicates a current value. A larger arrow indicates a larger current value, and a smaller arrow indicates a smaller current value. A communication frequency in a simulation is set to be 800 MHz (0.8 GHz).

As illustrated in FIG. 4, it is understood that the current flows in substantially one direction (right in FIG. 4) in both the antenna element 110 and the antenna element 120 in the non-conducting state. Further, it is understood that the current flows in the direction opposite (left in FIG. 4) to those in the antenna elements 110 and 120 along the end side 50B of the ground plane 50, and a large current value is obtained.

It is understood that, in the non-conducting state, both the antenna element 110 and the antenna element 120 emit a radio wave, and function as monopole antennas based on the current distribution.

As illustrated in FIG. 5, in a state corresponding to a case in which the gap between the open end 112 and the open end 132 is in the conducting state by the finger FT, the arrow is larger on the side on which the antenna element 120 is situated than on the side on which the antenna element 110 is situated. This indicates that the current dominantly flows into the antenna element 120. The current flowing in the antenna element 120 flows in substantially one direction (right in the FIG. 5).

The current which flows along the end side 50B of the ground plane 50 decreases slightly compared with the current in FIG. 4, and the current flows in the direction opposite to the currents in the antenna elements 110 and 120 (left in FIG. 5).

The current is decreased because, as illustrated in FIG. 4, the current flows into the antenna element 120 dominantly compared with a case where the radio wave is emitted in both the antenna element 110 and the antenna element 120, and the amount of the current flowing into the antenna element 110 is small.

Therefore, it is understood that the antenna element 120 emits the radio wave and functions as a monopole antenna in the conducting state based on the current distribution.

As described above, it is understood that the current flows into both the antenna element 110 and the antenna element 120 substantially uniformly in a non-conducting state, and the current flows into the antenna element 120 dominantly in the conducting state.

Therefore, lengths of the antenna elements 110 and 120 may desirably be set as follows. That is, in the non-conducting state, the lengths of the antenna elements 110 and 120 may desirably be set so that each of the antenna elements 110 and 120 may resonate at 800 MHz as a monopole antenna in a state where the antenna elements 110 and 120 are combined and operate in cooperation.

In the conducting state, the length of the antenna element 120 may desirably be set so that the antenna element 120 resonates at 800 MHz as a monopole antenna in a state where the antenna element 110 and the bezel 130 are in the conducting state.

The lengths of antenna elements 110 and 120 may desirably be set to satisfy these two conditions. The length of the antenna element 110 refers to as a length from the feeding unit 111 to the open end 112 via the bent portion 114. The length of the antenna element 120 refers to as a length from the feeding unit 111 to the open end 122 via the branching point 113 and the bent portions 121A and 121B.

As an example, when communicating at 800 MHz, the section between the feeding unit 111 and the bent portion 114 of the antenna element 110 is 11 mm in length. The section between the bent portion 114 and the open end 112 of the antenna element 110 is 70 mm in length, and the section between the bent portion 121B and the open end 122 of the antenna element 120 is 50 mm in length.

FIG. 6 illustrates current distribution of the antenna system 100 at 1.0 GHz in which the frequency characteristic of the S11 is a valley in the non-conducting state of FIG. 3. FIG. 6 illustrates current distribution in a non-conducting state.

In the current distribution illustrated in FIG. 6, compared with the current distribution illustrated in FIG. 4, a current value obtained in the antenna element 110 is higher than a current value obtained in the antenna element 120. This indicates that the antenna element 110 emits a radio wave dominantly. This is because the antenna element 110 is shorter than the antenna element 120.

Here, as illustrated in FIG. 5, in the state corresponding to the case in which the gap between the open end 112 and the open end 132 are made to conduct with each other by the finger FT, the current flows into the antenna element 120 dominantly. The current distribution illustrated in FIG. 5 is obtained at 0.8 GHz (800 MHz).

Therefore, by comparing FIGS. 4, 5 and 6, it is understood that the antenna element 110 contributes more to the radiation at 1.0 GHz and the antenna element 120 contributes more to the radiation at 800 MHz.

Since the antenna system 100 uses such antenna elements 110 and 120, the length of the antenna element 120 is longer than the length of the antenna element 110.

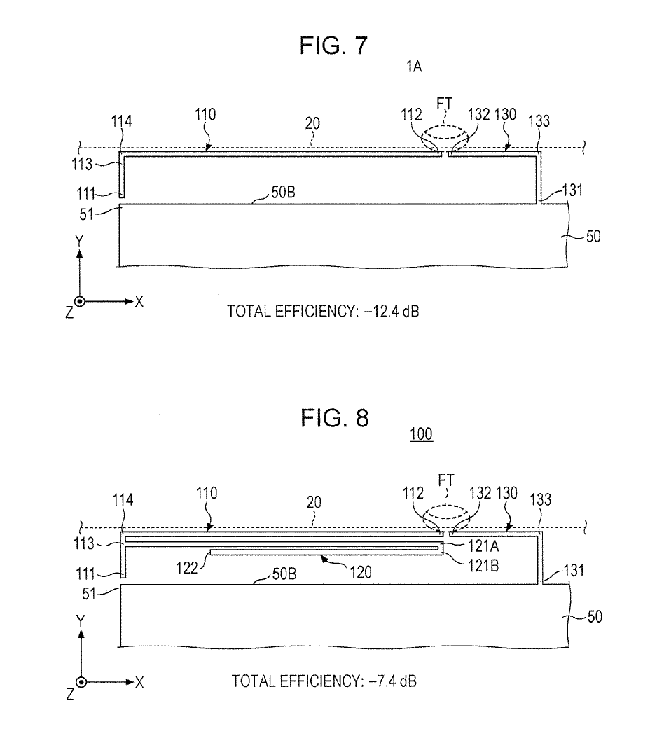

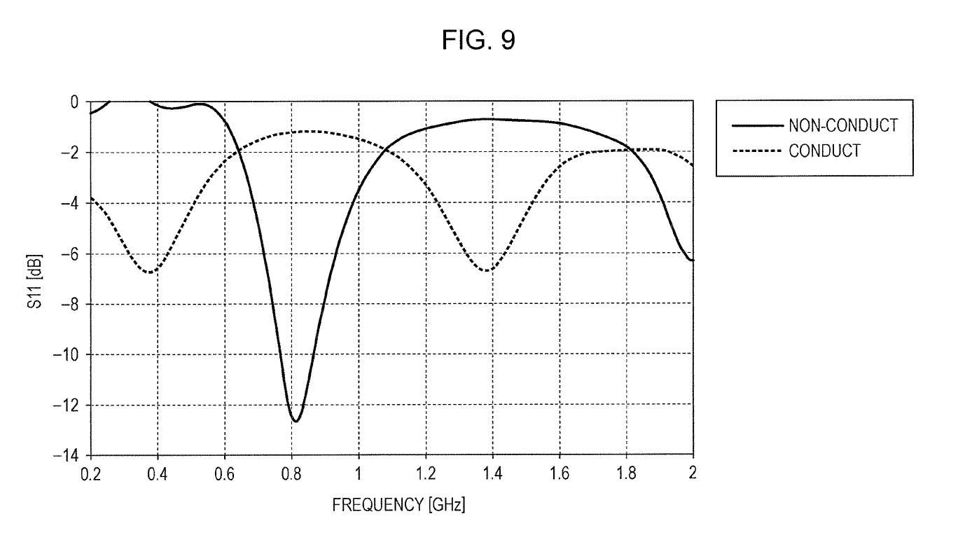

FIG. 7 illustrates a simulation model of a comparative antenna system 1A. FIG. 8 illustrates a simulation model of the antenna system 100. FIG. 9 illustrates a frequency characteristic of a S11 parameter obtained by the comparative antenna system 1A illustrated in FIG. 7.

The simulation model of the antenna system 100 illustrated in FIG. 8, which is the same as that of the antenna system 100 illustrated in FIG. 2, includes a ground plane 50, antenna elements 110 and 120, and a bezel 130.

The comparative antenna system 1A illustrated in FIG. 7 is the same as the antenna system 100 except that the antenna element 120 is removed therefrom. In particular, the section between the branching point 113 and the open end 122 of the antenna element 120 is removed from the antenna system 100.

In FIG. 9, in the comparative antenna system 1A, a frequency characteristic when the gap between the open end 112 and the open end 132 are in the non-conducting state (a non-conduct state) is depicted by a solid line, and a frequency characteristic when the gap between the open end 112 and the open end 132 are in the conducting state is depicted by a broken line.

In the frequency characteristic in the non-conducting state depicted by a solid line, a desirable value of equal to or less than −5 dB is obtained at target 800 MHz, whereas in the frequency characteristic in the conducting state depicted by a broken line, the value increases to about −1 dB at 800 MHz. A resonance frequency shifts to about 400 MHz in the frequency characteristic in the conducting state.

In the comparative antenna system 1A configured by removing the antenna element 120 from the antenna system 100 illustrated in FIG. 8, when the open end 112 and the open end 132 are made to conduct with each other by the finger FT of the user, a communication status deteriorates significantly and communication at 800 MHz becomes difficult.

Here, total efficiency at 800 MHz is calculated using the S11 parameter illustrated in FIG. 3 and the S11 parameter illustrated in FIG. 9. The total efficiency indicates characteristics of the electronic device 10 on which the antenna system 100 is mounted, and includes matching loss between impedances of the feeding unit 111 and the antenna system 100 and material loss of the material used in the antenna system 100.

Total efficiency at 800 MHz obtained in the comparative antenna system 1A illustrated in FIG. 7 is −12.4 dB. Total efficiency obtained in the antenna system 100 illustrated in FIG. 8 is −7.4 dB.

This result indicates that the existence of the section between the branching point 113 and the open end 122 of the antenna element 120 improves the total efficiency by 5 dB.

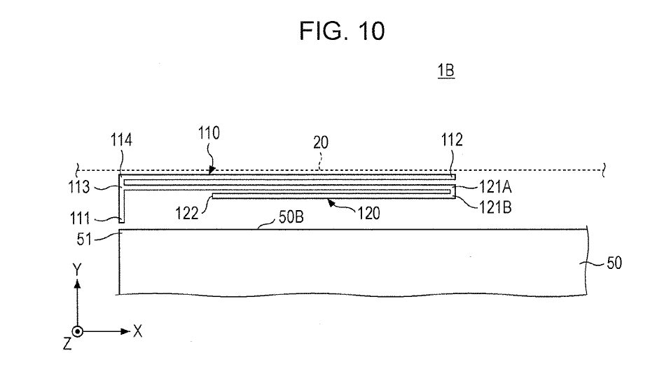

FIG. 10 illustrates a simulation model of a comparative antenna system 1B. The comparative antenna system 1B is the same as the antenna system 100 except that the bezel 130 is removed therefrom.

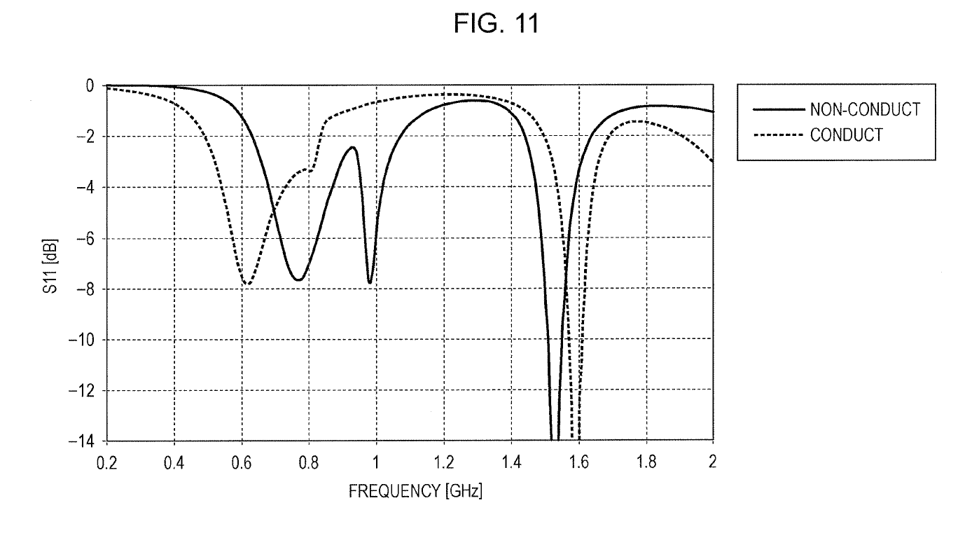

FIG. 11 illustrates a frequency characteristic of a S11 parameter of the antenna system 1B. In FIG. 11, a frequency characteristic when the open end 112 is not contacted by the finger is depicted by a solid line (non-conducting state), and a frequency characteristic when the open end 112 is contacted by the finger is depicted by a broken line (conducting state).

In the frequency characteristic in the non-conducting state depicted by a solid line, a desirable value of equal to or less than −5 dB is obtained at target 800 MHz.

In a frequency characteristic in the conducting state depicted by a broken line, about −3 dB is obtained at 800 MHz, which indicates that the frequency characteristic deteriorates from that in the non-conducting state depicted by a solid line. A resonance frequency is shifted to about 600 MHz.

This result indicates that absence of the bezel 130 decreases the communication status (communication quality) of the antenna element 120 of the antenna system 1B. That is, it is confirmed that, in the antenna system 100, existence of the bezel 130 makes communication of the antenna element 120 possible when the open end 112 and the open end 132 are in the conducting state by the finger FT.

According to the antenna system 100 of the embodiment, as described above, by providing the antenna element 110 and the bezel 130 which are exposed to the side surface of the housing 20 and providing the antenna element 120 which is not able to be touched from the outside of the housing 20, currents flow substantially equally in the antenna elements 110 and 120 when the open end 112 and the open end 132 are in the non-conducting state.

Therefore, in the non-conducting state, the antenna elements 110 and 120 function as monopole antennas to provide desirable communication characteristics.

In a state where there is the conducting state between the open end 112 and the open end 132, when a current flows into the antenna element 120 dominantly, the antenna element 120 functions as a monopole antenna to provide desirable communication characteristics. That the current flows into the antenna element 120 dominantly in the conducting state means that there is a little influence even when the open end 112 and the open end 132 are made to conduct by the finger FT.

Therefore, desirable communication characteristics are obtained both when there is non-conducting state between the open end 112 and the open end 132 and when there is the conducting state between the open end 112 and the open end 132.

Therefore, according to the embodiment, an antenna system 100 having desirable communication characteristics even when the conducting state between the open end 112 of the antenna element 110 and the open end 132 of the bezel 130 of ground potential is changed via a user's body may be provided.

The conducting state and the non-conducting state may be created when the user moves the hand while the user touches an outer periphery of the electronic device 10 with the finger FT, the palm, or the like, and the antenna system 100 can communicate desirably in either case.

In the antenna system 100 of the embodiment, switching of current paths (the antenna elements 110 and 120) in the non-conducting state and the conducting state is performed without using a switch. Since a desirable communication status is obtained at 800 MHz in either of the non-conducting state and the conducting state, an antenna system 100 which is implementable with a simple configuration and is highly reliable may be provided.

In order to switch the current paths (the antenna elements 110 and 120) in this manner, it is desirable to dispose the branching point 113 at which the antenna element 120 is branched from the antenna element 110 at a position as close to the feeding unit 111 as possible. Therefore, the branching point 113 is desirably situated between the feeding unit 111 and the bent portion 114.

An example in which the section from the bent portion 114 to the open end 112 of the antenna element 110 and the section from the bent portion 133 to the open end 132 of the bezel 130 are exposed to the side surface of the housing 20 has been described.

However, regarding the antenna element 110, the open end 112 may desirably be exposed to the housing 20 even when the bent portion 114 is not exposed to the housing 20. That is, the open end 112 side of the antenna element 110 may desirably be exposed to the housing 20.

Regarding the bezel 130, the open end 132 may desirably be exposed to the housing 20 even when the bent portion 133 is not exposed to the housing 20. That is, regarding the bezel 30, the open end 132 side may desirably be exposed to the housing 20.

The antenna system 100 which communicates at 800 MHz is described above. However, an antenna system 100 which communicates at frequencies other than 800 MHz may be implemented but by changing the length of the antenna elements 110 and 120.

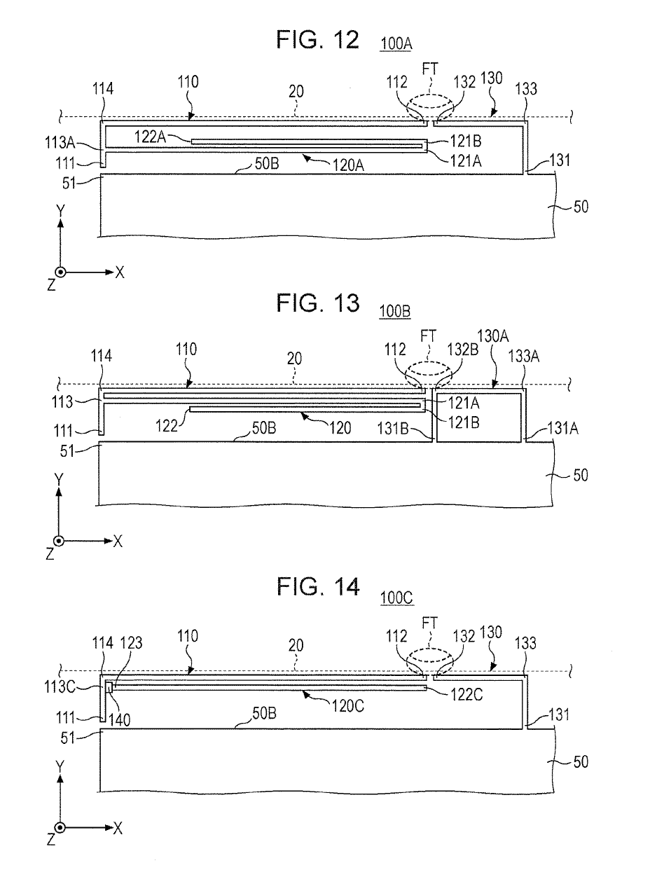

FIG. 12 illustrates an antenna system 100A according to a first alternative embodiment of the embodiment. FIG. 13 illustrates an antenna system 100B according to a second alternative embodiment of the embodiment.

The antenna system 100A illustrated in FIG. 12 includes a configuration in which the antenna element 120 of the antenna system 100 illustrated in FIG. 2 is replaced by an antenna element 120A. The antenna element 120A is branched at a branching point 113A from the antenna element 110, and extends in the positive direction of the X-axis to a bent portion 121A. The antenna element 120A is bent at the bent portion 121A in the positive direction of the Y-axis, extends to a bent portion 121B, is bent at the bent portion 121B in the negative direction of the X-axis, and extends to an open end 122A.

Also in the antenna system 100A including such an antenna element 120A, a desirable communication status is obtained at 800 MHz in either of a non-conducting state and a conducting state as in the antenna system 100.

The antenna system 100B illustrated in FIG. 13 includes a configuration in which the bezel 130 of the antenna system 100 illustrated in FIG. 2 is replaced by a bezel 130A.

The bezel 130A includes a connecting portion 131A, bent portions 133A and 133B, and a connecting portion 131B. The bezel 130A includes a line connecting the open end 132 of the bezel 130 and the end side 50B of the ground plane 50 illustrated in FIG. 2.

Also in the antenna system 100B including such a bezel 130A, a desirable communication status is obtained at 800 MHz in either of a non-conducting state and a conducting state as in the antenna system 100. The bezel 130A may be a metal plate which extends to the entire area surrounding the connecting portion 131A, the bent portions 133A and 133B, and the connecting portion 131B. The bezel 130A may have any shape as long as the bent portions 133A and 133B are exposed to the housing 20 and the bezel 13A is connected to the ground plane 50.

FIG. 14 illustrates an antenna system 100C according to a third alternative embodiment of the embodiment.

The antenna system 100C includes a configuration in which the antenna element 120 of the antenna system 100 illustrated in FIG. 2 is replaced by an antenna element 120C. An inductor 140 is mounted in series on the antenna element 120C at a branching point 113C at which the antenna element 12C is branched from the antenna element 110. The antenna element 120 is divided at a portion between the branching point 113C and the end portion 123, and the inductor 140 is connected in series between the branching point 113C and the end portion 123.

Thus, since the inductor 140 is mounted in series, the antenna element 120C can be made shorter than the antenna element 120 illustrated in FIG. 2, whereby a section from the end portion 123 to the end portion 122C becomes straight. A length between the branching point 113C and the end portion 122C is equal to a length of the line between the bent portion 114 and the open end 112.

When communicating at 800 MHz, for example, the length between the branching point 113C and the end portion 122C is 70 mm.

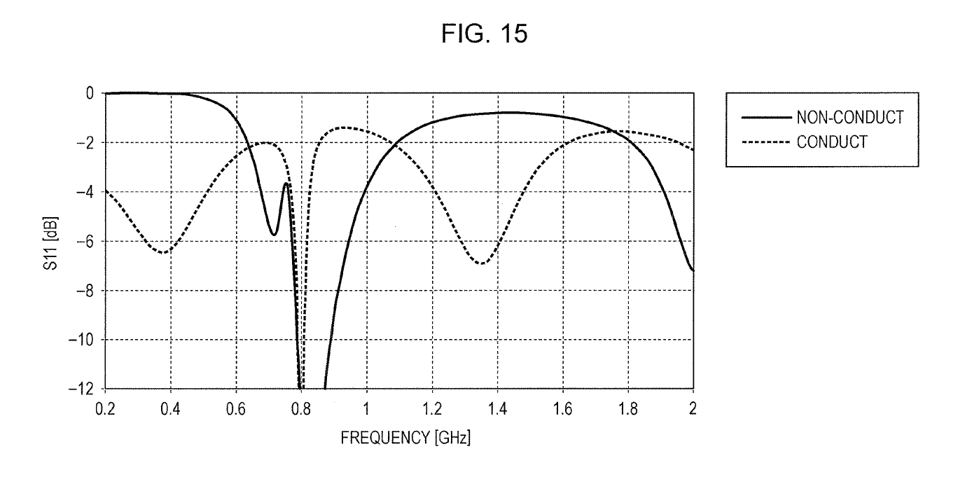

FIG. 15 illustrates a frequency characteristic of an S11 parameter of the antenna system 100C. In FIG. 15, a frequency characteristic when the open end 112 and the open end 132 are in the non-conducting state (a non-conduct state) is depicted by a solid line, and a frequency characteristic when the open end 112 and the open end 132 are in the conducting state is depicted by a broken line.

In the frequency characteristic in the non-conducting state depicted by a solid line, a desirable value of equal to or less than −5 dB is obtained at target 800 MHz.

Also in the frequency characteristic in the conducting state depicted by a broken line, a desirable value of equal to or less than −5 dB is obtained at target 800 MHz.

As described above, in the antenna system 100C according to the third modification of the embodiment, desirable communication characteristics are obtained as in the antenna system 100 illustrated in FIG. 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna system comprising:
a ground plane configured to be disposed inside of a housing and have an end side;
a first antenna element configured to include a first open end and a feeding point disposed at a certain position near the end side, the first antenna element being extend from the feeding point to the first open end, the first antenna element being exposed to an outside of the housing on the side of the first open end;
a second antenna element configured to include the feeding point and a second open end and be disposed between the end side and the first antenna element in a plan view, the second antenna element being branched from the first antenna element at a branching point between the feeding point and the first open end and extending to the second open end, a section between the branching point and the second open end being disposed inside of the housing or being covered with the housing and the first antenna element; and
a metal plate configured to include a connecting portion connected to the ground plane and an end portion disposed adjacent to the first open end, and extend from the connecting portion to the end portion, a portion of the metal plate near to the end portion being exposed to an outside of the housing.

2. The antenna system according to claim 1,
wherein the first antenna element is an inverted-L-shaped antenna element which includes a first line extending from the feeding point in a direction to separate from the end side, a bent portion bent along the end side at a tip of the first line, and a second line extending from the bent portion to the first open end along the end side.

3. The antenna system according to claim 1,
wherein the metal plate is exposed to the outside of the housing on the side of the end portion.

4. The antenna system according to claim 1,
wherein the branching point is situated between the feeding point and the bent portion.

5. The antenna system according to claim 1, further comprising
a coil mounted in series on the second antenna element at the branching point.

6. The antenna system according to claim 1,
wherein the first antenna element and the second antenna element are monopole antennas.

7. The antenna system according to claim 1,
wherein two or more sets of the first antenna elements and the second antenna elements are provided.

8. An electronic device comprising:
a ground plane configured to be disposed inside of a housing and have an end side;
a first antenna element configured to include a first open end and a feeding point disposed at a certain position near the end side, the first antenna element being extend from the feeding point to the first open end, the first antenna element being exposed to an outside of the housing on the side of the first open end;
a second antenna element configured to include the feeding point and a second open end and be disposed between the end side and the first antenna element in a plan view, the second antenna element being branched from the first antenna element at a branching point between the feeding point and the first open end and extending to the second open end, a section between the branching point and the second open end being disposed inside of the housing or being covered with the housing and the first antenna element; and
a metal plate configured to include a connecting portion connected to the ground plane and an end portion disposed adjacent to the first open end, and extend from the connecting portion to the end portion, a portion of the metal plate near to the end portion being exposed to an outside of the housing.
